(19) United States
(12) Patent Application Publication
(10) Pub. No.: US 2011/0118867 A1
(43) Pub. Date: May 19, 2011

(54) Device and Method for Turning in Virtual Planes

(75) Inventors: Gregory A. Hyatt, South Barrington, IL (US); Nitin Chaphalkar, Mount Prospect, IL (US)

(73) Assignee: MORI SEIKI CO., LTD., NARA (JP)

(21) Appl. No.: 12/954,163

(22) Filed: Nov. 24, 2010

Related U.S. Application Data
(63) Continuation of application No. 12/043,015, filed on Mar. 5, 2008, now abandoned.

(51) Int. Cl. G06F 19/00

(52) U.S. Cl. 700/186

(57) ABSTRACT

A turning method and apparatus includes a tool holding mechanism, such as a turret, and a workpiece holder, typically a chuck disposed on a main machine spindle. The tool holding mechanism may be translated in three directions relative to the workpiece holder, including a Z-direction that is along the axis of the rotation of the workpiece holder and X- and Y-directions orthogonal thereto. Under the control of the computer control system, the tool holding mechanism is moved in a direction having both an X- and Y-component relative to the workpiece holder.

### CROSS-REFERENCE TO RELATED APPLICATION

This application is a continuation in part of U.S. application Ser. No. 12/043,015, filed Mar. 5, 2008, which in turn claims the benefit of U.S. Provisional Application Ser. No. 61/262,363, filed on Nov. 18, 2009.

### TECHNICAL FIELD

This disclosure generally relates to turning operations, and more particularly to computer numerically controlled machines that may be used in machining operations.

### BACKGROUND OF THE DISCLOSURE

Turning operations employ a turning workpiece and a tool that engages the workpiece and that causes material to be removed from the workpiece. Conventional turning operations may be performed on a wide variety of machines of various types, ranging from simple manual lathes to complex computer numerically controlled machines with turning capabilities.

Some tools are configured for use in other machines and are difficult to employ on simpler lathes. Multiple function tools have been developed by Mazak (U.S. Pat. Nos. 6,532,849; 6,536,317; 6,578,643; and 6,078,382), Sandvik (U.S. Pat. No. 7,021,182), and Kennametal (U.S. Pat. No. 7,311,478). These tools were developed principally for use in mill-turn machines with automatic tool changers, liberal Y-axis travel, and indexing tool spindles. It can be inconvenient to employ such tools in a lathe that is not equipped with an automatic tool changer and in which Y-axis travel is more limited.

In addition, it can be necessary to change tools frequently. In a typical turreted lathe, the turret turns to expose a different tool for each facet. The time of turning is limited in part by the rotation of the turret to move different tools into and out of position. This can limit throughput in high volume operations. Additionally, in high volume operations, tools can become worn quickly. To minimize the machine downtime, it is thus desirable to maximize the number of tools that can be carried on the turret. Additionally, maximizing the number of tools that can be carried on the turret may allow for an increase in the number of other tools used for other operations, such as milling.

### SUMMARY OF THE DISCLOSURE

Conventionally computer numerically control lathes employ a tool holding apparatus that is movable in axes that are fixed with respect to the base of the machine. Turning operations employed by moving the cutting tool relative to the workpiece in one of the axes. Conventionally, the Z-direction is the axis that is coextensive with the axis of rotation of the workpiece, while the X- and Y-directions are respectively axes that are orthogonal thereto. These axes are defined by the physical construction of the machine, whereby typically the X and Y axes are defined by tracks or rails in which the tool carriage is moved. It has now discovered that it is possible to move the turning tool relative to the workpiece in a virtual plane, that is, a direction that is oblique to the X- and Y-directions, under the control of the computer numerically control system. In the virtual plane, the tool will have both an X- and Y-component of motion. In some cases the tool will also have a Z-axis component of motion.

Turning in virtual planes permits a number of advantages, one or more of which may be realized in the various embodiments of the invention. In some embodiments, for instance, a convex tool holder may be employed to increase the number of tools available on a facet of a turret in the computer numerically control machine. If it is desired to use plural tools in the turning operation, the tools may be caused to engage the workpiece without rotating the turret. In other embodiments, tools with multiple inserts that are not orthogonally disposed may be employed in the machine, and a desired insert may be caused to engage the workpiece by moving the tool in a virtual plane.

In one embodiment, an apparatus is provided. The apparatus includes the tool holding mechanism, which may be a turret, and a workpiece holder. The tool holding mechanism is movable in three directions of translations relative to the workpiece, at least two of the axis of the translation being fixed relative to the base of the apparatus and defined by the construction of the machine. These directions include a Z-direction, which coextends with the axis of rotation of the workpiece holder (and ordinarily the workpiece when the workpiece is disposed therein) and an X- and a Y-direction each orthogonal to the Z-direction. The apparatus includes a computer control system that is operatively coupled to the tool holding mechanism and to the workpiece holder. The computer control system includes computer readable program code, that, when executed, causes the tool holding mechanism to be moved relative to the workpiece holder in a plane that is oblique to the X and Y directions, i.e., that has both an X- and Y-component, when a tool in the tool holder engages the workpiece.

In another embodiment, a method is provided. Through the use of an apparatus as discussed above, a rotating workpiece is brought into engagement with a tool in a virtual plane that is oblique to the X and the Y directions.

The invention also provides, in some embodiments, unique tools that are usable in connection with the apparatus and method disclosed herein. In accordance with one embodiment, a hollow OD turning tool is provided. The tool includes at least one tool insert that is inwardly disposed. An apparatus that includes such tool and a method for turning using such tool also are provided.

### BRIEF DESCRIPTION OF THE DRAWINGS

For a more complete understanding of the disclosed methods and apparatuses, reference should be made to the embodiment illustrated in greater detail on the accompanying drawings.

FIG. 1 is a front elevation of a computer numerically controlled lathe, shown with the safety door opened and illustrating the headstock, tailstock, and turret of the machine.

FIG. 2 is a front elevation of the computer numerically controlled lathe of FIG. 1, shown with the safety door closed.

FIG. 3 is a perspective view of a conventional gang tool holder, the holder being provided with four turning tools.

FIGS. 4A and 4B each are representations of a conventional turning operation using the gang tool holder and tools illustrated in FIG. 3.

FIG. 5 is a respective view of a multi-insert tool useful in conjunction with certain embodiments of the invention.

FIG. 6 is a view taken in the Z-axis of a conventional turning operation using an ID turning tool with four orthogonally disposed inserts.

FIG. 7 is a view taken in the Z-axis of a turning operation employing an OD turning tool with four orthogonally disposed inserts.

FIG. 8 is a view taken in the Z-axis of an ID turning operation in a virtual plane employing the tool and workpiece illustrated in FIG. 6.

FIG. 9 is a representation taken in the Z-axis of an ID turning operation employing the tool and workpiece illustrated in FIG. 5.

FIG. 10 is a view taken in the Z-axis of an OD turning operation in a virtual plane illustrating the tool and workpiece shown in FIG. 7.

FIG. 11 is a side view of the turret of the machine illustrated in FIG. 1, illustrating convex tool holders and a multi-insert radially disposed tool operating on a workpiece.

FIG. 12 is a side view of the turret of the machine illustrated in FIG. 1, illustrating a concave tool holder and four radially disposed tool inserts.

FIG. 13 is a representation of a convex tool holder that includes five radially disposed tools.

FIGS. 14 and 15 are two alternative embodiments of concave tool holders each including five radially disposed tools.

FIG. 16 is a view taken in the Z-axis of a turret including a concave tool holder and three radially disposed tools disposed thereon and illustrating turning of a workpiece in the X axis.

FIG. 17 is a view taken in the Z-axis of a turret including a concave tool holder and three radially disposed tools disposed thereon and illustrating turning of a workpiece in a first virtual plane.

FIG. 18 is a view taken in the Z-axis of a turret including a concave tool holder and three tools disposed thereon and illustrating turning of a workpiece in a second virtual plane.

FIG. 19 is a perspective view of an alternative concave tool holder, the tool holder permitting axial mounting of tools.

FIG. 20 is a perspective view of the tool holder of FIG. 19, illustrating several axially disposed tools mounted thereon.

FIG. 21 is a view taken in the Z-axis of a turning operation employing the tools and tool holder illustrated in FIG. 20.

FIG. 22 is a perspective view of the chuck of the machine illustrated in FIGS. 1 and 2, further illustrating a conventional tool presetter.

FIG. 23 is a first alternative embodiment, and FIG. 24 a second alternative embodiment, of a tool presetter stylus useful in conjunction with some embodiments of the present invention.

FIG. 25 is a perspective view of certain internal components of the computer numerically controlled machine illustrated in FIG. 1.

FIG. 26 and FIG. 27 are representations of Y-axis tool travel in the computer numerically controlled machine illustrated in FIG. 25.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

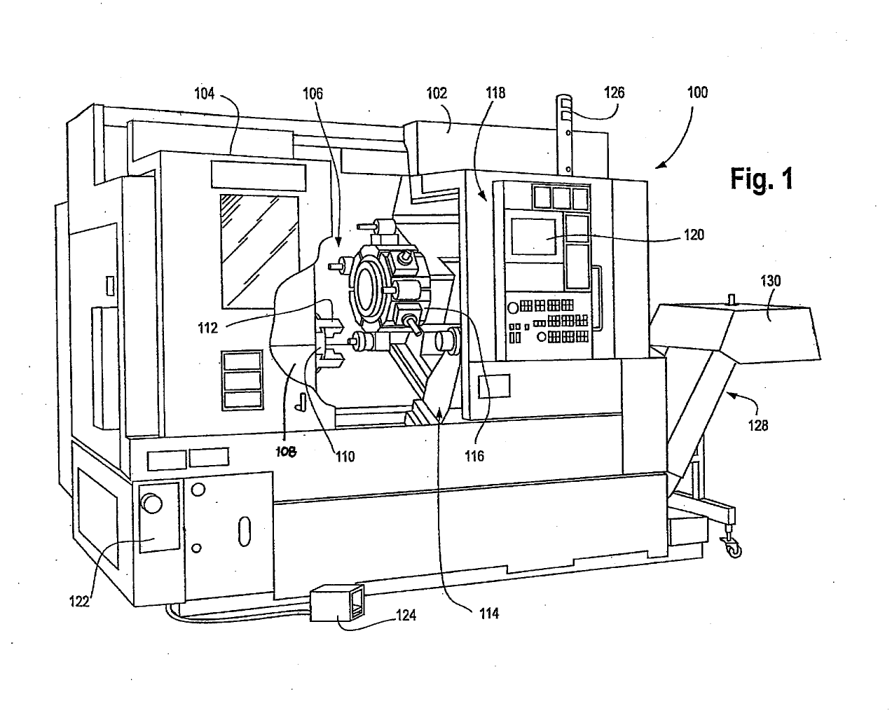

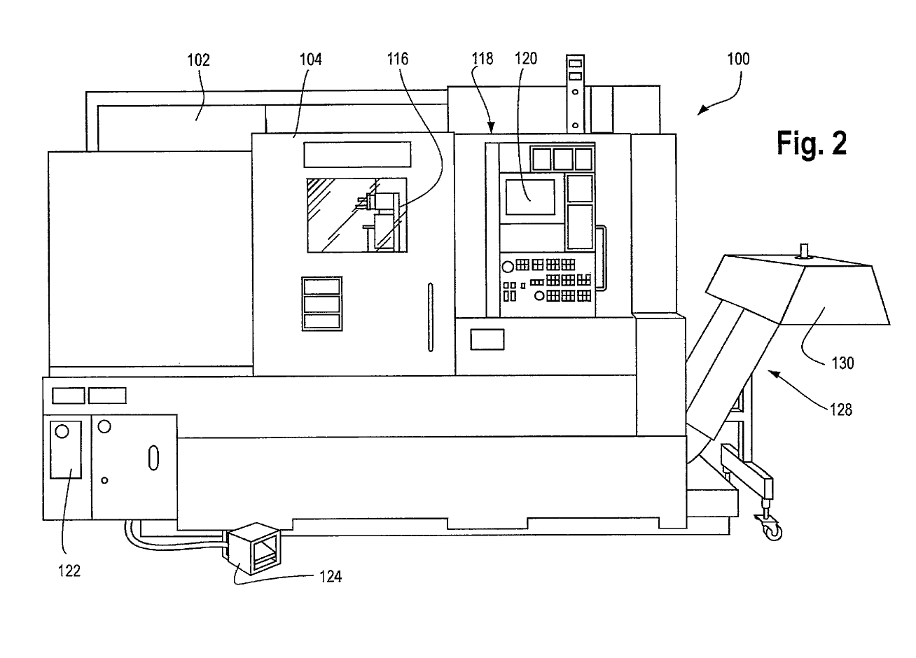

With reference now to FIGS. 1 and 2, the illustrated computer numerically controlled machine 100 is an NL-Series lathe sold by Mori Seiki USA, Inc., Rolling Meadows, Ill., the assignee of the present patent application. It is contemplated that the invention is useful in or may be embodied in other machines, such as the NT- and NZ-Series machines, also sold by Mori Seiki USA. The invention is deemed particularly suitable for use in connection with the NL-Series machine as depicted. The NL-series machines typically are less expensive than the NT-series machines. The NL-series machines, however, typically are not equipped with automatic tool changers, and, as set forth in more detail hereinbelow, the Y-axis range of motion of tools in the machine is more limited than of tools in the NT-series machines.

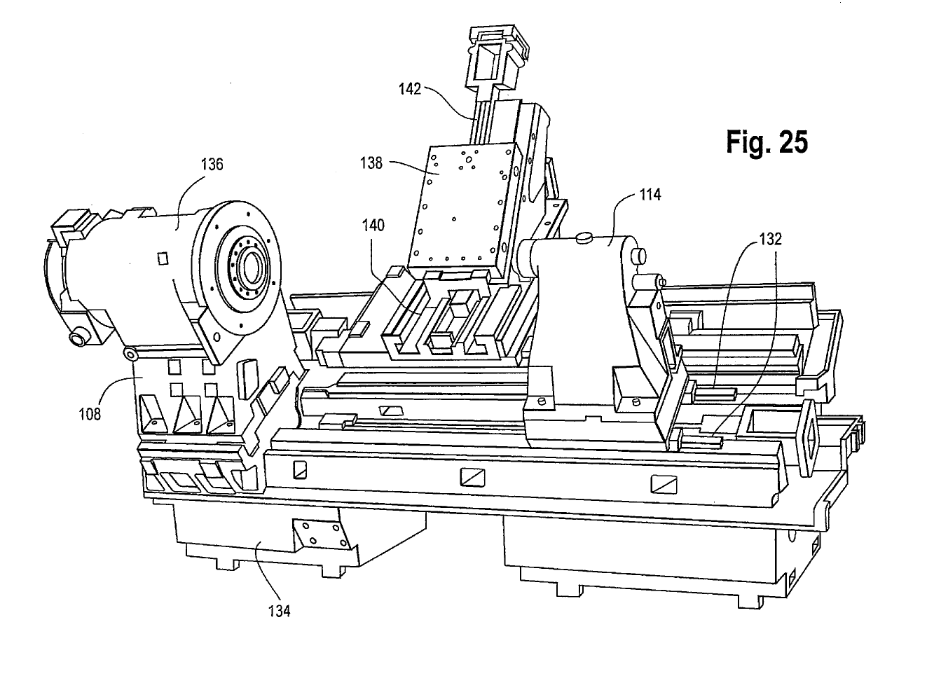

As illustrated, the machine 100 includes a housing 102 with a safety door 104 that may be opened to access the interior working space 106. The machine includes a number of operating components, including a headstock 108 (FIG. 25) equipped with a chuck 110 with jaws 112 that are equipped to grip a workpiece. In the illustrated embodiment, the machine includes a tailstock 114 that is equipped to retain an end of the workpiece. In some embodiments the invention, a second chuck (not illustrated) may be employed in place of the tailstock. The illustrated tailstock 114 is movable in the Z-direction to accommodate workpieces of various sizes. The machine 100 further includes a turret 116, which, in the illustrated embodiment, has twelve facets, but which may have a greater or smaller number of facets, such as eight facets or twenty facets.

The computer numerically controlled machine is equipped with a computer control system 118 which is operatively coupled to the headstock and turret and to most or all of the other operating components. In the illustrated embodiment, the machine is provided with two interlinked computer systems, a first computer system comprising a user interface system (shown generally at 120 in FIG. 2) and a second computer system (not illustrated) operatively coupled to the first computer system. The second computer system directly controls the operation of the components of the machine while the user interface system 120 allows an operator to control the second computer system. Collectively, the machine control system and the user interface system, together with the various mechanisms for control of operations in the machine, may be considered a single computer control system. In some embodiments, the user operates the user interface system to impart program into the machine; in other embodiments, programs can be loaded or transferred into the machine via external sources. It is contemplated, for instance, the programs may be loaded via a PCMCIA interface, an RS-232 interface, a Universal Serial Bus interface (USB), or a network interface, in particular, a TCP/IP network interface. In other embodiments, the machine may be controlled via conventional PLC (programmable logic controller) mechanisms (not illustrated). The computer control system may be provided with conversational programming features to enable facile programming of the machine for turning in virtual planes.

The illustrated machine is equipped with a chuck pressure control and gage 122 which are manual, and a chuck actuation pedal 124. The machine further is equipped with a status light tree 126 and a chip conveying device 128 with a chip conveyer 130. The status light tree indicates different operating states of the machine via a lit display. In some embodiments, a computer numerically controlled machine may be provided with other components, such as a workpiece feeding device (not shown), various tool changing mechanisms (also not shown), and other components. Generally, the machine may be equipped with a coolant delivery mechanism (not shown) and optionally lighting, cameras, and other conventional components.

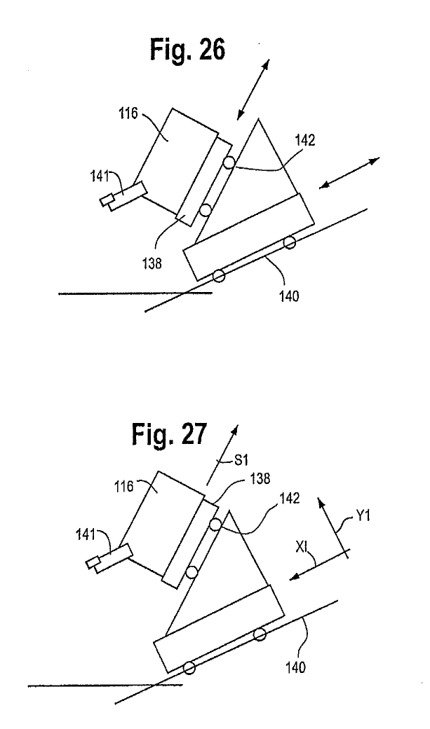

Turning now to FIGS. 25-27, it is seen that the tailstock 114 is movable under the control of the computer control system along rails 132 in the Z-direction to enable the tailstock to be brought into and out of engagement with the workpiece (not shown). The headstock 108, which is stationary relative to the base 134 of the machine 100, is equipped with a motor 136 for turning the chuck. The turret (not shown in FIG. 25) rests on a bed 138 that moves on primary rails 140 that are disposed in, and which define, the X-direction of the machine. Machine Y-direction motion is accomplished in the illustrated embodiment by motion of the turret bed 138 along both primary rails 140 and secondary rails 142. The position in the X-axis of the turret 116 and hence the tool 141 connected thereto may be stationary; a Y-slide vector (Y1 in FIG. 27) is defined based on X-axis motion (X1) and secondary rail motion (S1). In the illustrated embodiment, it is seen that the Y-axis range of travel is more limited than the X-axis range of travel of the turret.

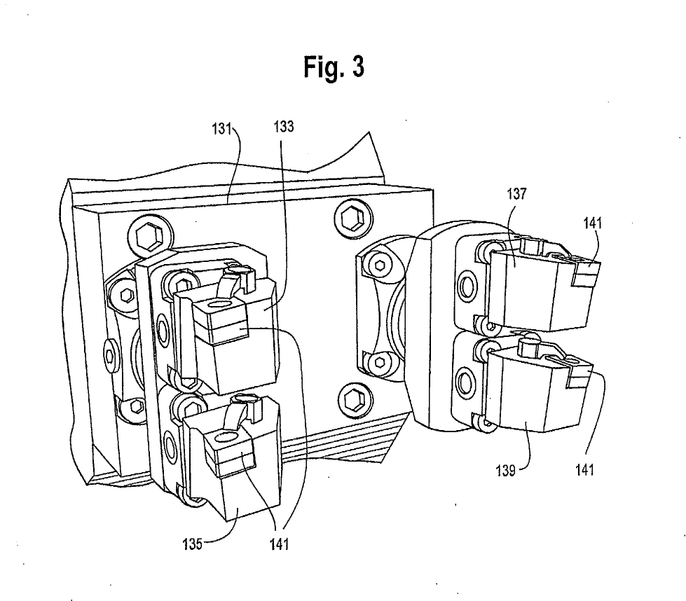

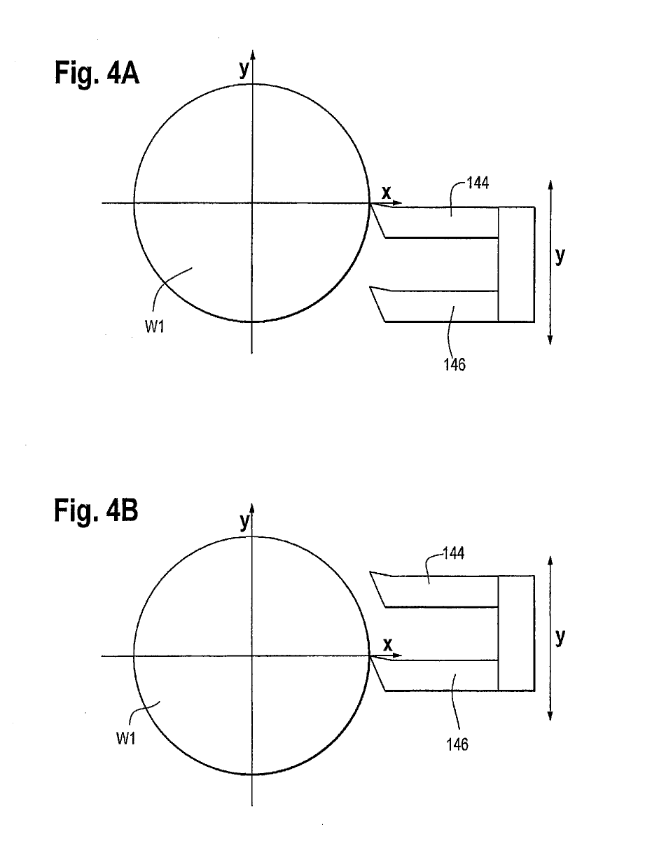

A conventional turning operation, such as an operation conducting a gang tool holder 131 and tools 133, 137, 139 illustrated in FIG. 3, is represented in FIGS. 4A and 4B. The tools each contain a single insert 141. The “insert” of a tool is the portion that engages the workpiece, and it is contemplated that the insert generally is replaceable. In some embodiments, the insert may be integral with the body of the tool, and hence “insert” is not limited to a separable piece. As illustrated, it is conventional for the first tool 144 to engage the workpiece W1 and for the tool 144 to move in the X-direction, which, again, is a physical direction defined by the construction of the machine. At some point it may become desirable to switch to turning with the second tool 146. For instance, it may be desired to cause dissimilar tools to engage the workpiece, or it may be desired to change to a new tool after the first tool has become worn out. In such case, the first tool 144 is moved relative to the workpiece in the Y direction and the second tool 146 caused to engage the workpiece W1, again with motion in the X direction. Generally, it is desired to bring the tool insert onto the center line of the workpiece in the turning operation and to move the tool radially towards the center of the workpiece, although it is contemplated that other turning operations are possible.

With reference now to FIG. 5, the multi-insert tool 150 depicted therein includes a drilling portion 152 defined by drill insert 154 and drill and bore insert 156, the cutting faces of which are disposed at 180.degree. relative to one another on the shaft 158 of the tool 150. The multi-insert tool includes a finished bore tool 160 and a threading tool 162 which are disposed at oblique angles with respect to each of the drilling inserts 154, 156. This tool is principally designed for a mill-turn machine such as the Mori Seiki NT Series Machine, in which an upper tool spindle provides for rotational control of the angular position of the tool inserts. However, it can be difficult to position this tool properly in the NL-Series Machine.

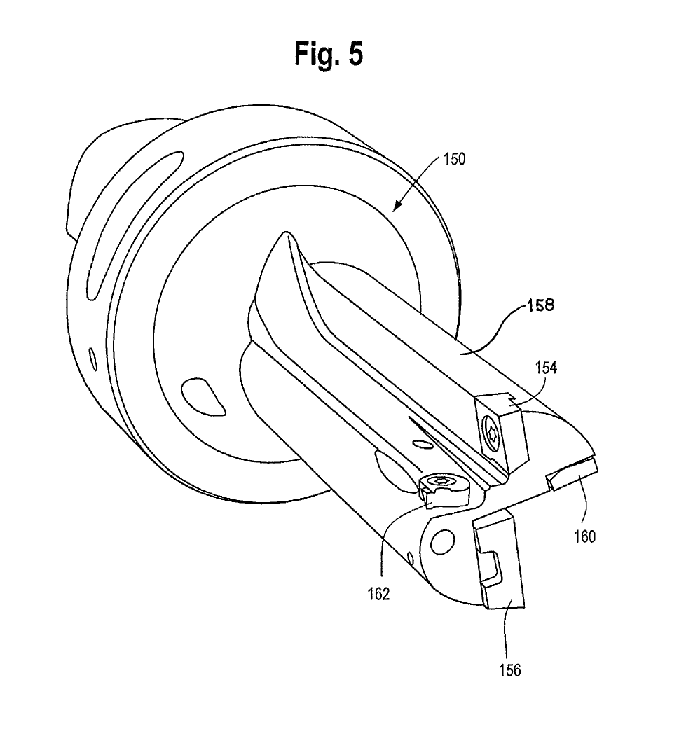

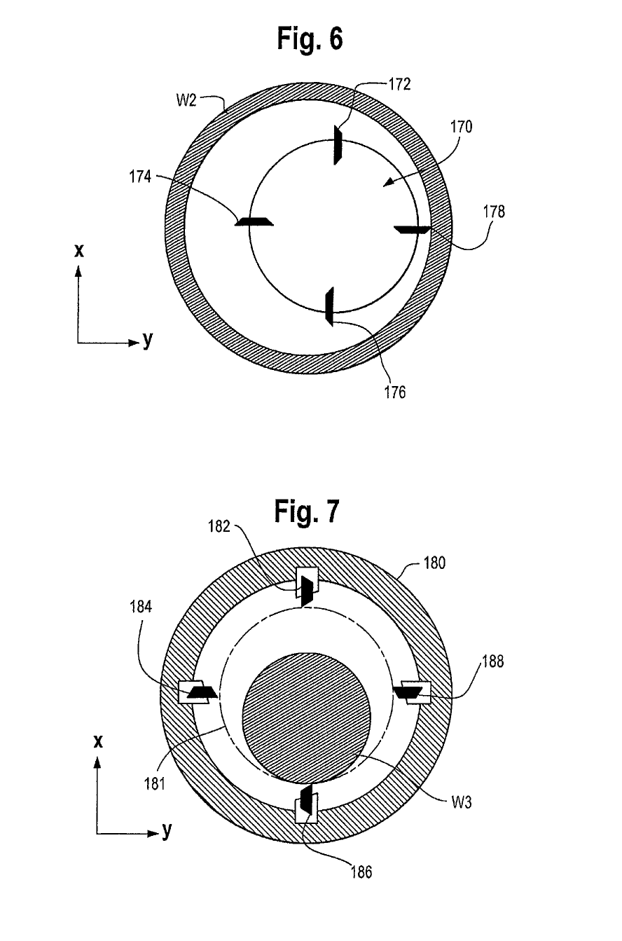

The turning operation may be an ID (inside diameter) turning operation or an OD (outside diameter) turning operation. As illustrated in FIG. 6, for instance, the tool 170 includes four orthogonally disposed tool inserts 172, 174, 176, 178. One of the tool inserts 172 is caused to engage the workpiece W2, which rotates in a turning operation. Whether it is desired to turn with a different tool insert, the tool 170 is moved relative to the workpiece to bring the desired tool insert into engagement with the workpiece.

With reference now to FIG. 7, an outside diameter turning operation employs novel OD turning tool 180 with tool inserts 182, 184, 186, 188, one of which is shown as engaging the workpiece W3. The maximum accommodated diameter of the workpiece is indicated by circle 181. This tool may be moved in an X- and Y-direction in a turning operation and also may be moved to present different tool inserts.

Use of a hollow tool as depicted affords certain advantages. A user may preplace multiple inserts onto a tool. When a customer uses a single machine to prepare a variety of parts, this preconfigured tool may be stored assembled and ready for use. When the machine is next set up to produce the part for which the specific tool configuration is desired, the desired tool configuration may be arranged quickly by installing the hollow tool. If the tool is not registered correctly, a single master offset can correct the position of every insert on the tool.

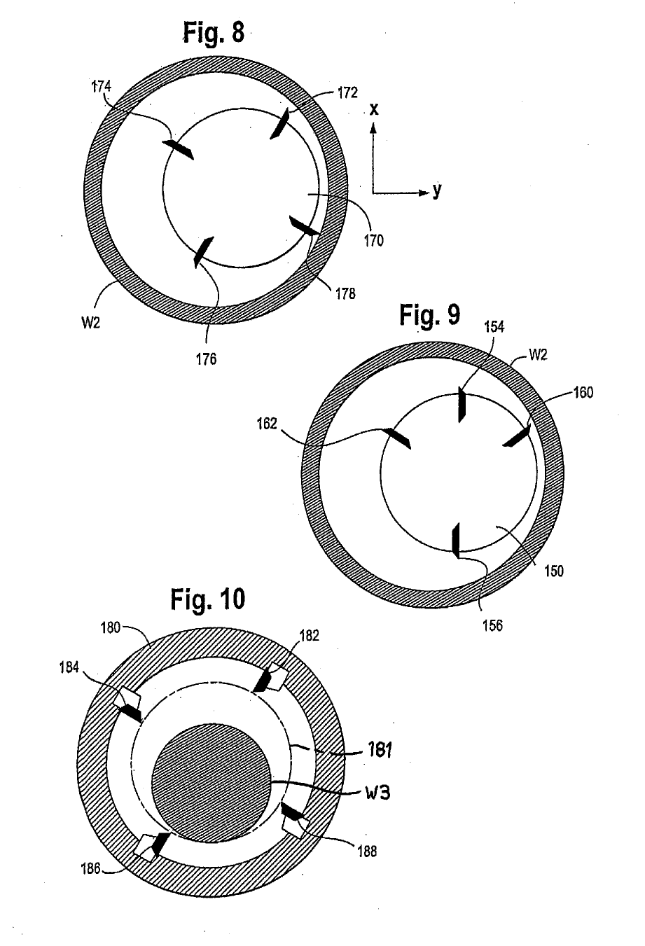

With reference now to FIG. 8, it is seen that the position of the tool 170 has been changed such that the inserts 172, 174, 176, 178 no longer move in the X- or Y-axes when engaging the workpiece W2, but move in a plane that is oblique thereto. In accordance with this embodiment of the invention, the computer numeric control system causes movement of the turret relative to the tool holder and tool connected thereto in each of an X- and Y-direction simultaneously to produce thereby a motion vector in the oblique plane. As illustrated, the tool inserts 172, 174, 176, 178 remain orthogonal to one another, but it is contemplated that the inserts 172, 174, 176, 178 may be non-orthogonal. Thus, as shown in FIG. 9, the multi-insert tool 150 may be employed, and any of the inserts 154, 156, 160, 162 caused to engage the workpiece W2 via motion of the tool in a virtual plane. Similarly, with reference to FIG. 10, the tool 180 may be rotated relative to the workpiece W3 and may be brought to engage the workpiece in a virtual plane. A tool may be constructed similarly to the tool depicted but may have tool inserts that are not orthogonal with respect to one another.

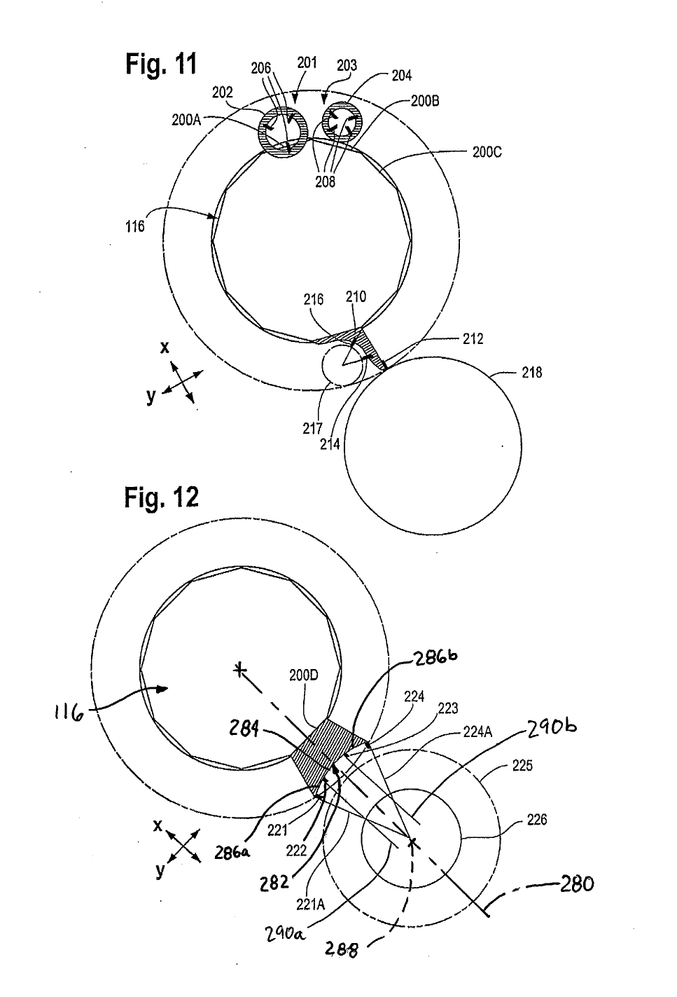

It is thus seen that various configurations for the tool holder and tools are possible. With respect to FIG. 11 and FIG. 12, for instance, the turret 116 may contain turret holders that are convex. As shown in FIG. 11, for instance, plural tool holders 200A, 200B, 200C each are convex. Tool holders 200A, 200B include tools operating on workpieces 202, 204, such as with inserts 206, 208 shown in various turning operations. Tool 210 has a complex profile carrying plural tool inserts 212, 214, 216. Inserts 214 and 216 are suitable for movement in a virtual plane, respectively, to engage in a workpiece (not shown) with a maximum diameter presented by circle 217 while insert 212 may be positioned conventionally to engage a larger workpiece as represented by circle 218. Areas 201, 203 represent the tool operating envelope for the tools disposed on tool holders 200A, 200B, the envelope restricted by the swing clearance of the turret 116. It is contemplated that tool may extend beyond the maximum tool boundary where there is clearance between tools on adjacent facet of the turret or if there are not tools on the adjacent facet of the turret.

The diameter of the hollow OD turning tool may be selected in part based on the machine configuration and in part based on the chip removal properties of the workpiece. For tools of larger diameters, a cantilevered arrangement may be used. As to chip removal, where chip crowding is an issue, it is preferred to use a larger tool diameter. In some embodiments a segment of the tool may be removed. Where chip removal is not a problem, smaller diameters will minimize chip-to-chip time.

Alternatively, the tool holder may be concave, as illustrated in FIG. 12 with respect to tool holder 200D. From FIG. 12 it will be appreciated that a normal working axis 280 extends from a center point 288 of the workpiece to the turret 116 in a direction orthogonal to the Z-axis. In the illustrated embodiment, the normal working axis 280 extends in the X-direction. As noted above, the turret 116 is supported for movement in the X-, Y-, and Z-directions. Movement in the Y-direction is limited to a Y-direction travel range. Accordingly, while the normal working axis 280 is illustrated as being aligned with a center point of the turret 116, it will be appreciated that the turret 116 may be displaced from the illustrated position in the Y-direction relative to the workpiece holder.

The tool holder 200D is coupled to the turret 116 and includes an arcuate tool holder surface 282, which in the illustrated embodiment is a concave surface, facing the workpiece holder. Due to the limited movement of the turret 116 in the Y-direction, the tool holder surface 282 may be divided into two separate regions. A first region 284 is capable of being placed on the normal working axis 280. That is, the first region 284 corresponds to that portion of the tool holder surface 282 that can be placed on the normal working axis 280 as the turret 116 traverses the Y-direction travel range. Consequently, the width of the first region 284 is defined by the Y-direction travel range. The boundaries of the first region 284 are indicated by lines 290a, 290b.

A second region 286 corresponds to that portion of the tool holder surface 282 that is separate from the first region 284. The second region 286 lies outside of the Y-direction travel range and therefore cannot be placed on the normal working axis 280. In the illustrated embodiment, the first region 284 is disposed on a central portion of the tool holder surface 282 and the second region 286 includes first and second sections 286a, 286b disposed on opposite edges of the first region 284. While the second region 286 is shown having two sections 286a, 286b, it will be appreciated that the second region 286 may include a single section.

In FIG. 12, tool holder 200D is illustrated as having four tools 221, 222, 223, 224, attached to the tool holder surface 282. Two of the tools, namely tools 222 and 223, are coupled to the first region 284 of the tool holder surface 282. As illustrated, tool 222 is aligned with boundary 290a of the first region 284 while tool 223 is aligned with boundary 290b of the first region. These tools 222, 223 therefore may be placed on the normal working axis 280 as the turret 116 traverses the Y-direction travel range. Because the turret 116 typically has a maximum range of travel in the X-direction when a tool is aligned along the working axis 280, the tools 222, 223 disposed in the first region 284 may be configured to traverse a tool path extending to the axis of rotation 288 of the workpiece during operation. Additionally, these tools 222, 223 are capable of engaging smaller workpieces, such as the workpiece represented by circle 226. Tools 222 and 223 are shown as being positioned at the edges of the first region 284 and therefore illustrate a width of the first region 284 (which corresponds to the length of the Y-direction travel range of the turret 116). While two tools 222, 223 are shown as being disposed in the first region 284, it will be appreciated that a single tool or more than two tools may be provided in the first region 284.

Tools 221 and 224 are disposed in the second region 286 of the tool holder surface 282 and therefore are incapable of being placed on the normal working axis 280. Thus, to be capable of engaging a workpiece, the tools 221, 224 are driven along an axis that is different from the normal working axis 280. Movement of the turret 116 in the X-direction is more limited along axes that are not the normal working axis, and therefore tools 221, 224 are configured to traverse a tool path that stops short of the workpiece axis of rotation 288 during operation. Consequently, the tools 221, 224 are capable of engaging only relatively larger workpieces, such as the workpiece represented by circle 225. While two tools 221, 224 are shown as being disposed in the second region 286, it will be appreciated that a single tool or more than two tools may be provided in the second region 286.

The turret 116 may be operated in a normal plane mode and a virtual plane mode to use all of the tools 221-224 disposed on the tool holder surface 282. In the normal plane mode, the turret 116 is moved relative to the workpiece holder in a normal plane extending along the normal working axis to engage one of the tools 222, 223 disposed in the first region 284 with the workpiece. Once the turret 116 has completed travel in the Y-direction to place the selected tool along the normal working axis 280, turret movement in the normal plane mode is substantially in the X-direction, as is conventional. In the virtual plane mode, the active tool is displaced from the normal working axis 280. In the virtual plane mode, turret movement relative to the workpiece holder is in a virtual plane that is oblique to the X- and Y-directions to engage a selected tool 221 or 224 with the workpiece. The virtual plane may intersect the workpiece axis of rotation 288, such as the virtual planes represented by line 221A and line 224A for tools 221 and 224, respectively. The workpiece holder may be controlled to rotate in a first direction in the normal plane mode and a second, opposite direction in the virtual plane mode.

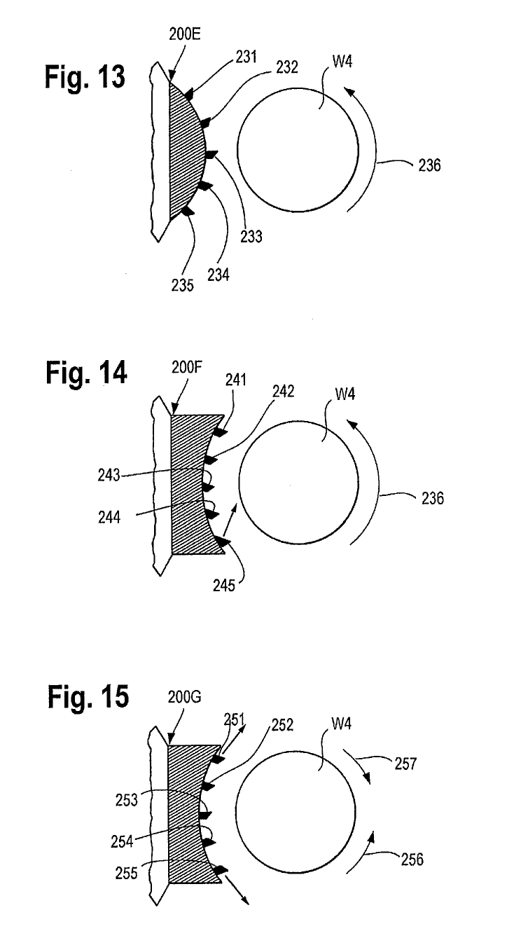

With respect to FIG. 13, convex tool holder 200E includes five tools, 231, 232, 233, 234, 235. These tools are radially disposed tools; that is, they extend from the tool holder 200E in a direction that does not break the planes defined by each face of the turret 116. In this direction, the tools are so oriented that the workpiece W4 should rotate in the direction of arrow 236 to allow chips to be properly carried away. The tools 231, 232, 233, 234, 235 may be oriented in various positions relative to the tool holder 200E. For instance, with respect to the concave tool holders 200F, 200G illustrated in FIGS. 14, and 15, it is seen that tools 241, 242, 243 in FIG. 14 and tools 251, 252, 253 in FIG. 15 are similarly disposed, but tools 244, 245 in FIG. 14 are disposed in the opposite direction from tools 254, 255 in FIG. 15. Thus, when brought to bear against a workpiece W4, the workpiece should rotate in a first direction 256 when engaging tools 251, 252, and 253 in FIG. 15 and in a second direction 257 opposite the first direction 256 when engaging tools 254 and 255 in FIG. 15.

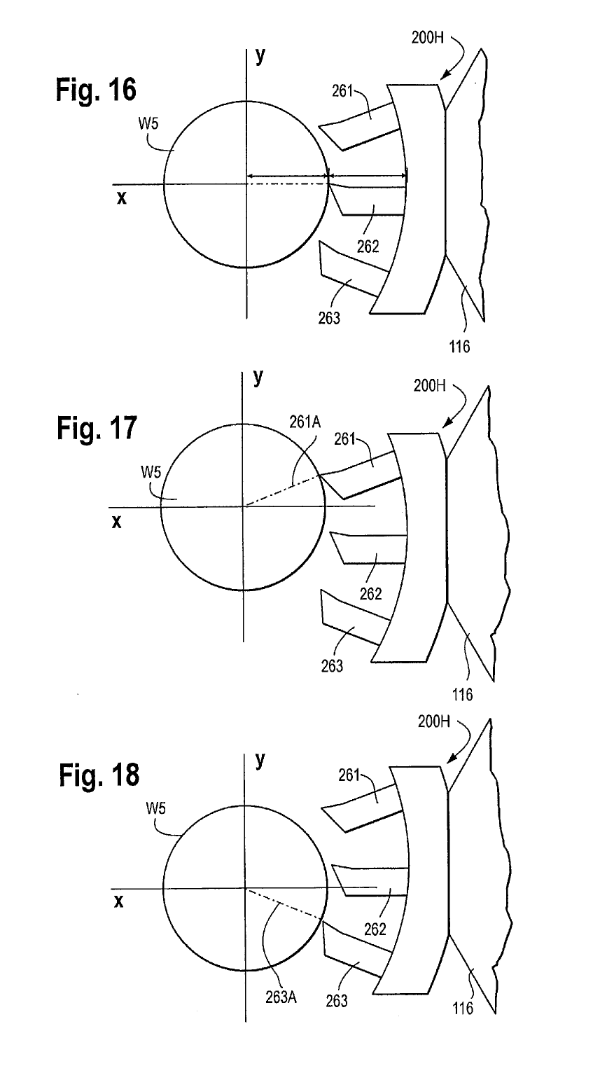

With reference to the tool holder 200H illustrated in FIGS. 16 though 18, it is seen that a conventional turning operation may be employed using central tool 262 disposed on the tool holder 200H and moving the tool in the X-direction. It is seen with this concave tool holder 200H that the diameter of the workpiece W5 is limited by the clearance afforded by tools 261, 262, 263. As shown in FIG. 17, when it is desired to employ cutting tool 261 under the control of the computer control system, the turret 116 is moved in direction 261A, which is a first virtual plane oblique to the X and Y axes. Similarly, with reference to FIG. 18, when it is desired to turn with tool 263, the turret 116 is moved in direction 263A which is a second virtual plane oblique to the X and Y axes.

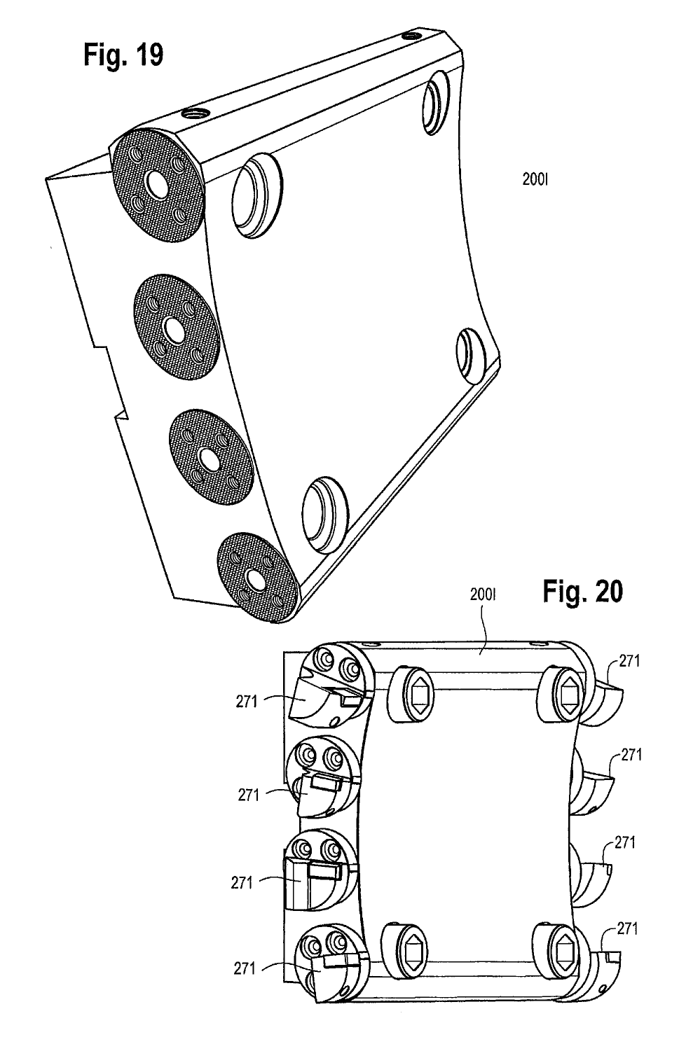

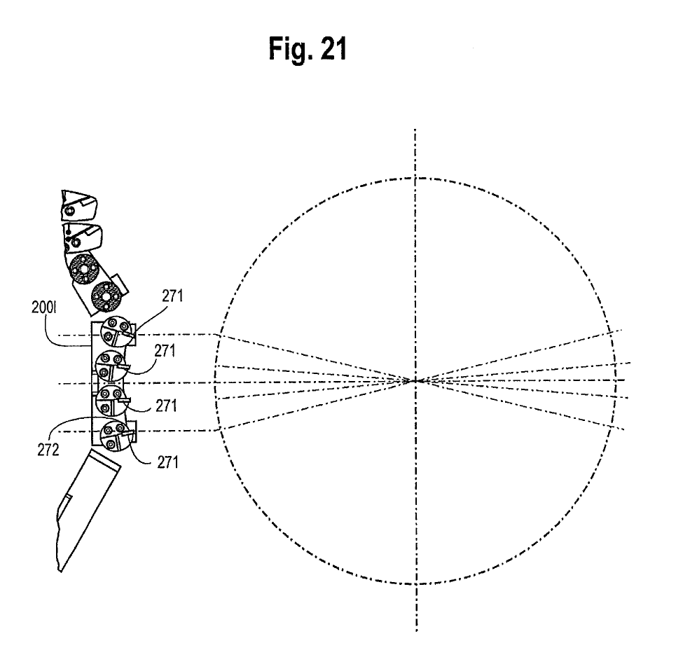

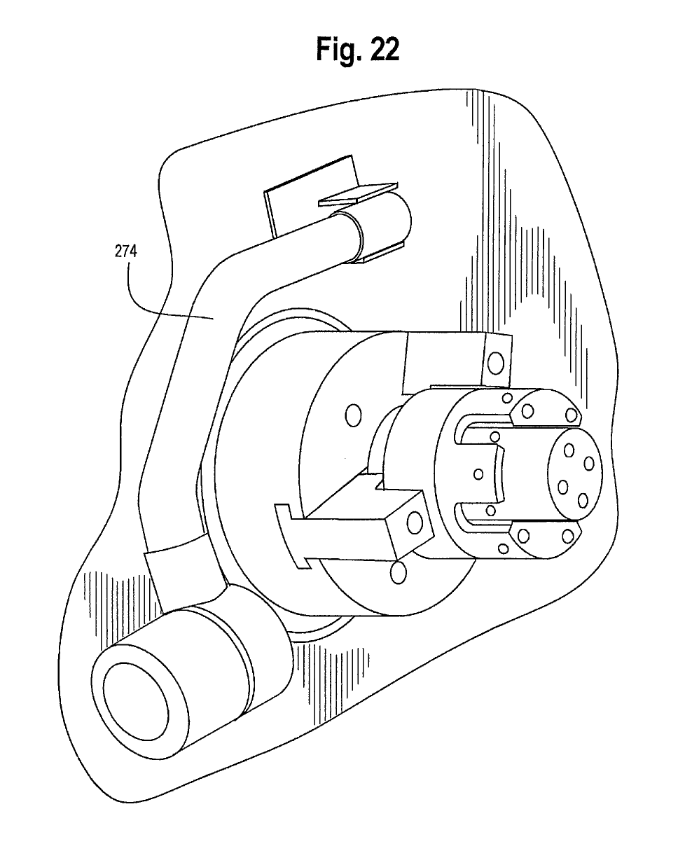

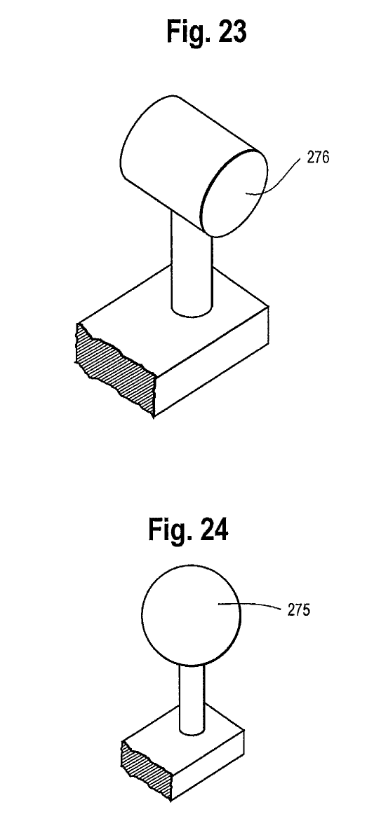

In addition to employing radially disposed tools or as an alternative thereto, the turret may be provided with axially disposed tools disposed on a suitable equipped tool holder. Axially disposed tools break the plane of the turret and/or have a shaft that is generally parallel to the axis of rotation of the turret. As illustrated in FIGS. 19 and 20, for instance, tool holder 200I includes several tools 271 each disposed axially on a tool holder. Each tool is movable in its own virtual plane relative to a workpiece, as illustrated in FIG. 21 with respect to tools 271 on first side 272 of the tool holders. In the illustrated embodiment, tools 271 are disposed on both sides of the tool holder; generally, this arrangement is most suitable for use with a second chuck disposed in lieu of tailstock 114.

A conventional turning operation employs a tool presetter, such as presetter 274 illustrated in FIG. 22. The presetter helps register the position of the tool in the machine. Because movement in a virtual plane carries with it a motion in both X and Y axes, the tool presetter as shown in FIG. 22 (which is suitable for motion in the position of the tool in the X direction) may not be suitable. A presetter stylus having a generally spherical tip 275, as is illustrated in FIG. 24, will be perpendicular to the tip of the tool when moving in any plane. In some embodiments the presetter stylus may have a generally circular cylindrical form 276, as shown in FIG. 23. Alternatively, the presetter shown in FIG. 22 may be employed and the position of the tool calculated using appropriate algorithms. Due to limited Y-axis travel, some tools may not be able to travel in a virtual plane a sufficient distance towards the chuck to employ the conventional presetting device. In such cases, a stylus with an appropriately sized diameter should be employed. In an alternative embodiment, the tool may be put on a slide with bearings and accurate notches on the slide used to hold the tools at a specific angle. The slide would then be moved to bring the tool on a Y0 plane, thus permitting measurement of the tool in a traditional matter.

Generally, and especially for workpieces of complex configuration (such as workpieces on which other operations have been performed prior to turning), it is desired to avoid interference between tools and between the tool and the workpiece. The CNC software may create a program for tool operation that accounts for the required clearances. Additionally or alternatively, the CNC software also may have a solid model of the tool to calculate enable avoidance of interference with the machine and workpiece. This software may be implemented using conventional conversational programming tools.

It is contemplated that additional operations, such as milling, may be performed on a workpiece either before or after a turning operation. Likewise, it is contemplated that some turning operations may employ turning both in virtual planes and conventional turning.

In certain operations, particularly high volume operations, it is desired to manage tool life, by which it is contemplated keeping track of the turning time experienced by each tool insert. In accordance with the present invention, the machine software may be provided with algorithms for tool life management of individual tool inserts.

It is thus seen that an apparatus and method for turning in virtual planes are provided in one or more of the various embodiments of the inventions.

All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. The patents referenced herein are hereby incorporated by reference in their entireties, in particular for their disclosure of tools.

What is claimed is:

1. An apparatus comprising:
a workpiece holder configured to retain and rotate a workpiece about an axis of rotation;
a tool holding mechanism movable in three directions of translation relative to the workpiece holder, the directions of translation including a Z-direction coextending with the workpiece axis of rotation, an X-direction, and a Y-direction, wherein the X- and Y-directions are orthogonal to the Z-direction, a normal working axis extending in the X-direction between the tool holding mechanism and workpiece axis of rotation, and wherein movement of the tool holding mechanism in the Y-direction is limited to a Y-direction travel range;
a tool holder coupled to the tool holding mechanism and having an arcuate holder surface facing the workpiece, the tool holder surface including a first region capable of being placed on the normal working axis as the tool holding mechanism traverses the Y-direction travel range and a second region separate from the first region;
a first tool coupled to the tool holder surface first region;
a second tool coupled to the tool holder surface second region; and
a computer control system operatively coupled to the tool holding mechanism and to the workpiece holder, the computer control system including computer readable program code configured to:
operate in a normal plane mode, in which the tool holding mechanism is positioned so that the first tool is disposed on the normal working axis and the tool holding mechanism is moved relative to the workpiece holder along a normal plane extending along the normal working axis to engage the first tool with the workpiece; and
operate in a virtual plane mode, in which the tool holding mechanism is positioned so that the second tool is displaced from the normal working axis and the tool holding mechanism is moved relative to the workpiece holder along a virtual plane that is oblique to the X- and Y-directions to engage the second tool with the workpiece.

2. The apparatus of claim 1, in which the arcuate holder surface comprises a concave holder surface.

3. The apparatus of claim 1, in which the arcuate holder surface comprises a convex holder surface.

4. The apparatus of claim 1, in which the tool holder mechanism comprises a rotary turret.

5. The apparatus of claim 1, in which the first tool is configured to traverse a tool path extending to the axis of rotation during operation.

6. The apparatus of claim 5, in which the second tool is configured to traverse a tool path stopping short of the axis of rotation during operation.

7. The apparatus of claim 1, in which the tool holder surface first region is disposed on a central region of the tool holder surface.

8. The apparatus of claim 7, in which the tool holder surface second region includes first and second sections disposed on opposite edges of the tool holder surface first region.

9. The apparatus of claim 1, in which the computer readable program code is further configured to rotate the workpiece holder in a first direction in the normal plane mode and to rotate the workpiece holder in a second, opposite direction in the virtual plane mode.

10. A method comprising:
providing a workpiece holder configured to retain and rotate a workpiece about an axis of rotation;
providing a tool holding mechanism movable in three directions of translation relative to the workpiece holder, the directions of translation including a Z-direction coextending with the workpiece axis of rotation, an X-direction, and a Y-direction, wherein the X- and Y-directions are orthogonal to the Z-direction, a normal working axis extending in the X-direction between the tool holding mechanism and the workpiece axis of rotation, and wherein movement of the tool holding mechanism in the Y-direction is limited to a Y-direction travel range;
providing a tool holder coupled to the tool holding mechanism and having an arcuate holder surface facing the workpiece, the tool holder surface including a first region capable of being placed on the normal working axis as the tool holding mechanism traverses the Y-direction travel range and a second region separate from the first region;
providing a first tool coupled to the tool holder surface first region;
providing a second tool coupled to the tool holder surface second region;
operating in a normal plane mode, in which the tool holding mechanism is positioned so that the first tool is disposed on the normal working axis and the tool holder mechanism is moved relative to the workpiece holder along a normal plane extending along the normal working axis to engage the first tool with the workpiece; and
operating in a virtual plane mode, in which the tool holding mechanism is positioned so that the second tool is displaced from the normal working axis and the tool holding mechanism is moved relative to the workpiece holder along a virtual plane that is oblique to the X- and Y-directions to engage the second tool with the workpiece.

11. The method of claim 10, in which the arcuate holder surface comprises a concave holder surface.

12. The method of claim 10, in which the arcuate holder surface comprises a convex holder surface.

13. The method of claim 10, in which the tool holder mechanism comprises a rotary turret.

14. The method of claim 10, in which the first tool is configured to traverse a tool path extending to the axis of rotation during operation.

15. The method of claim 14, in which the second tool is configured to traverse a tool path stopping short of the axis of rotation during operation.

16. The method of claim 10, in which the tool holder surface first region is disposed on a central region of the tool holder surface.

17. The method of claim 16, in which the tool holder surface second region includes first and second sections disposed on opposite edges of the tool holder surface first region.

18. The method of claim 10, further comprising a computer control system operatively coupled to the tool holding mechanism and to the workpiece holder, the computer control system including computer readable program code configured to execute the normal plane mode operation and the virtual plane mode operation.

19. The method of claim 10, further comprising rotating the workpiece holder in a first direction in the normal plane mode and rotating the workpiece holder in a second, opposite direction in the virtual plane mode.
